(19) United States
(12) Patent Application Publication
(10) Pub. No.: US 2021/0180394 A1
(43) Pub. Date: Jun. 17, 2021

(54) CONNECTING DEVICE

(71) Applicant: GUANGDONG KIN LONG HARDWARE PRODUCTS CO., LTD, Dongguan (CN)

(72) Inventor: Baokun BAI, Dongguan (CN)

(21) Appl. No.: 15/931,263

(22) Filed: May 13, 2020

(30) Foreign Application Priority Data
Dec. 11, 2019 (CN) 201911268595.8

(51) Int. Cl. E06B 3/54; E04B 2/88

(52) U.S. Cl. CPC E06B 3/5481; E04B 2/88

(57) ABSTRACT

The present disclosure relates to a connecting device, which includes a clamping mechanism, a transverse arm mechanism, a main arm member and a connecting mechanism that are sequentially connected. The clamping mechanism includes a clamping block and a fixing member. The transverse arm mechanism includes a mounting base, a positioning member and a fastening member. The fixing member connects the clamping block and the mounting base. The positioning member is connected to one end of the mounting base away from the clamping mechanism. The fastening member connects the positioning member and the mounting base. The main arm member extends through the mounting base. The connecting mechanism is provided with a connecting rod connected to the main arm member.

### CROSS REFERENCE TO RELATED APPLICATION

This application claims the benefit of Chinese Patent Application No. 201911268595.8, filed on Dec. 11, 2019, the entire content of which is incorporated herein in its entirety.

### TECHNICAL FIELD

The present disclosure relates to a technical filed of glass fixing apparatus, in particular, to a connecting device.

### BACKGROUND

With the continuous development of point supported glass curtain walls, its application fields and scope continue to expand, and different geographical environments have put forward higher requirements for the stability of point supported glass curtain walls to ensure the safety of people's lives and property and create a living environment with safety and comfort. Since coastal cities and areas with relatively active earthquakes have a higher chance of hurricanes and strong earthquakes, these areas require higher stability of point supported connecting systems. However, most point supported connecting member in the current market generally cannot effectively resist hurricanes, strong earthquakes and the like.

### SUMMARY

Accordingly, it is necessary to provide a connecting device having a simple structure and being convenient to use to address the above problems.

A connecting device includes a clamping mechanism, a transverse arm mechanism, a main arm member and a connecting mechanism that are sequentially connected. The clamping mechanism includes a clamping block and a fixing member. The transverse arm mechanism includes a mounting base, a positioning member and a fastening member. The fixing member connects the clamping block and the mounting base. The positioning member is connected to one end of the mounting base away from the clamping mechanism. The fastening member connects the positioning member and the mounting base. The main arm member extends through the mounting base. The connecting mechanism is provided with a connecting rod connected to the main arm member.

According to the connecting device of the present disclosure, the clamping block, the mounting base, the main arm member, and the connecting rod are connected as a whole, and the clamping block clamps the glass, the connecting rod is connected to building structural parts, thus, the self-weight, wind load, earthquake load and the like of the glass can be transmitted to the building structural parts. The connecting device of the present disclosure has a simple structure and is convenient to use. It can ensure the stability of the curtain wall system and improve the safety performance of the curtain wall system under the strong loads such as hurricanes and earthquakes.

In one of the embodiments, the main arm member includes a latching portion, a guiding portion and a limiting portion that are sequentially connected. The latching portion protrudes from the guiding portion. The guiding portion is slidably arranged in the mounting base. The limiting portion is connected to the connecting rod.

In one of the embodiments, a width of a cross-section of the limiting portion gradually increases from one end thereof adjacent to the guiding portion to the other end thereof.

In one of the embodiments, the main arm member further includes a convex block protruding from the guiding portion.

In one of the embodiments, the clamping block includes a first clamping portion, a second clamping portion, and a connecting portion connecting the first clamping portion and the second clamping portion. The first clamping portion cooperates with the second clamping portion to clamp the glass.

In one of the embodiments, the clamping mechanism further includes an abutting block, and a first elastic member and a second elastic member that are sleeved on an end of the fixing member away from the clamping block. Both sides of the abutting block abut against the first elastic member and the second elastic member, respectively.

A connecting device includes a clamping mechanism, a transverse arm mechanism, a main arm member and a connecting mechanism that are sequentially connected. The clamping mechanism includes a clamping block and a fixing member. The transverse arm mechanism includes a mounting base and a fastening member. The fixing member connects the clamping block and the mounting base. The main arm member extends through the mounting base. The fastening member connects the main arm member and the mounting base. The connecting mechanism is provided with a connecting rod connected to the main arm member.

In one of the embodiments, the clamping mechanism further includes an abutting block, and a first elastic member and a second elastic member that are sleeved on an end of the fixing member away from the clamping block. Both sides of the abutting block abut against the first elastic member and the second elastic member, respectively.

In one of the embodiments, the main arm member includes a guiding portion and a limiting portion that are sequentially connected. The guiding portion is slidably arranged in the mounting base. The limiting portion is connected to the connecting rod.

In one of the embodiments, the main arm member further includes a convex block protruding from the guiding portion.

### BRIEF DESCRIPTION OF THE DRAWINGS

FIG. 1 is a structural schematic view of an assembled state of a connecting device according to a first embodiment of the present disclosure.

FIG. 2 is a structural schematic view of a clamping mechanism and a transverse arm mechanism in the connecting device as shown in FIG. 1.

FIG. 3 is an exploded view of the clamping mechanism and the transverse arm mechanism in the connecting device as shown in FIG. 2.

FIG. 4 is an exploded view of the transverse arm mechanism and a connecting mechanism in the connecting device as shown in FIG. 1.

FIG. 5 is a structural schematic view of a min arm member in a connecting device according to a second embodiment of the present disclosure.

FIG. 6 is a schematic view of a clamping mechanism and a transverse arm mechanism in a connecting device according to a third embodiment of the present disclosure.

FIG. 7 is a schematic view of the clamping mechanism and the transverse arm mechanism in the connecting device as shown in FIG. 6, where a first elastic member and a second elastic member are not shown.

FIG. 8 is a schematic view of the first elastic member and the second elastic member as rubber pads in the connecting device as shown in FIG. 6.

FIG. 9 is a structural schematic view of an assembled state of a connecting device according to a fourth embodiment of the present disclosure.

FIG. 10 is an exploded view of the transverse arm mechanism in the connecting device as shown in FIG. 9.

FIG. 11 is a structural schematic view of a main arm member in the connecting device as shown in FIG. 9.

FIG. 12 is a structural schematic view of a main arm member in a connecting device according to a fifth embodiment of the present disclosure.

FIG. 13 is a schematic view of a clamping mechanism and a transverse arm mechanism in a connecting device according to a sixth embodiment of the present disclosure.

FIG. 14 is a schematic view of the clamping mechanism and the transverse arm mechanism in the connecting device as shown in FIG. 13, where a first elastic member and a second elastic member are not shown.

FIG. 15 is a schematic view of the first elastic member and the second elastic member as rubber pads in the connecting device as shown in FIG. 13.

### REFERENCE NUMERALS LIST

100—connecting device, 10—clamping mechanism, 11—clamping block, 111—first clamping portion, 112—second clamping portion, 113—connecting portion, 12—fixing member, 20—transverse arm mechanism, 21—mounting base, 210—receiving groove, 22—positioning member, 23—fastening member, 30—main arm member, 31—latching portion, 32—guiding portion, 33—limiting portion, 40—connecting mechanism, 41—connecting rod, 42—buffer member, 43—sleeve, 30a—main arm member, 32a—guiding portion, 34a—convex block, 10b—clamping mechanism, 11b—clamping block, 12b—fixing member, 13b—abutting block, 14b—first elastic member, 15b—second elastic member, 20b—transverse arm mechanism, 21b—mounting base, 22b—positioning member, 24b—fixing base, 100c—connecting device, 20c—transverse arm mechanism, 21c—mounting base, 210c—through hole, 23c—fastening member, 30c—main arm member, 32c—guiding portion, 33c—limiting portion, 30d—main arm member, 32d—guiding portion, 34d—convex block, 10e—clamping mechanism, 11e—clamping block, 12e—fixing member, 13e—abutting block, 14e—first elastic member, 15e—second elastic member, 20e—transverse arm mechanism, 21e—mounting base, 210e—through hole, 24e—fixing base.

### DETAILED DESCRIPTION OF THE EMBODIMENTS

For the convenience of understanding of the present disclosure, the present disclosure will be more fully described. However, the present disclosure can be implemented in many different forms and is not limited to the embodiments described herein. In contrast, the purpose of providing these embodiments is to providing a fully and thoroughly understanding of the disclosure of the present disclosure.

Unless defined otherwise, all technological and scientific terms used herein have the same meaning as commonly understood by one of those skilled in the art to which present disclosure belongs. The terms used herein in the specification of the present disclosure are only for describing specific embodiments, and are not intended to limit the present disclosure.

### Embodiment 1

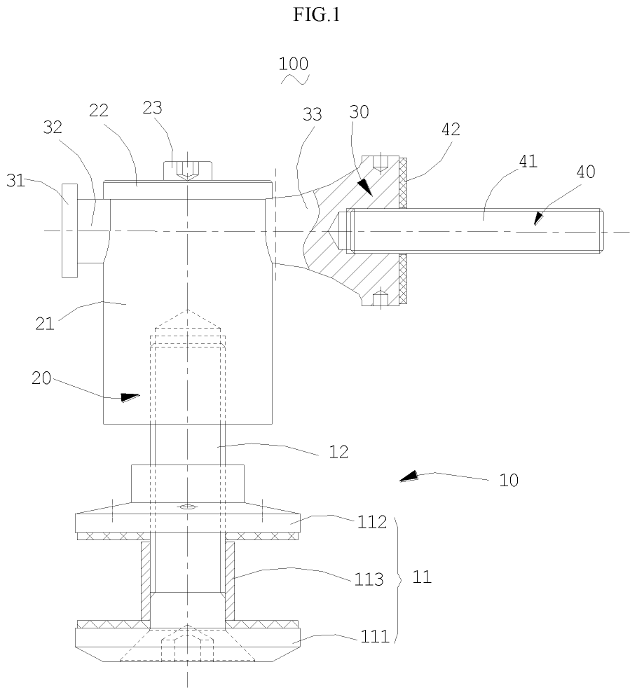

Referring to FIGS. 1 to 4, a connecting device 100 according to an embodiment of the present disclosure includes a clamping mechanism 10, a transverse arm mechanism 20, a main arm member 30, and a connecting mechanism 40 that are sequentially connected. According to the connecting device 100 of the present disclosure, the clamping mechanism 10, the transverse arm mechanism 20, the main arm member 30, and the connecting mechanism 40 are connected as a whole, and the clamping mechanism 10 clamps glass, the connecting mechanism 40 is connected to building structural parts, thus, the self-weight, wind load, earthquake load and the like of the glass can be transmitted to the building structural parts.

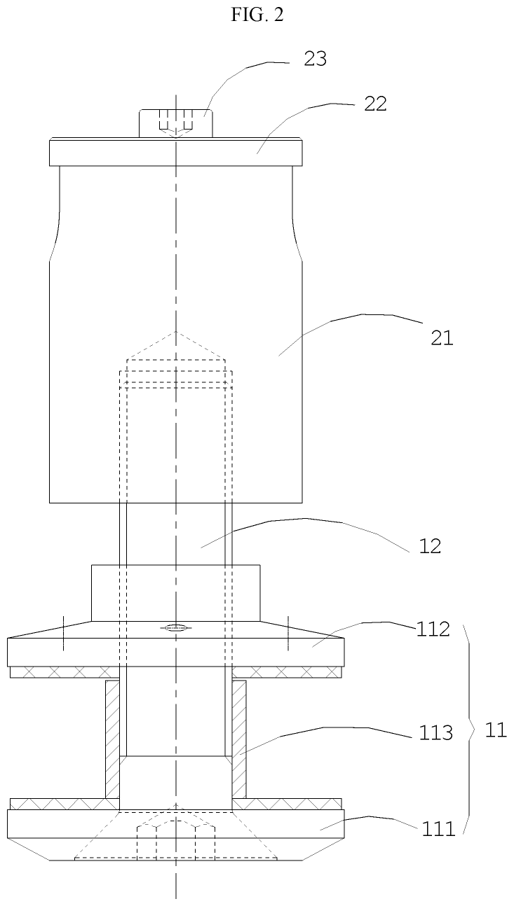

As shown in FIGS. 1 and 2, in this embodiment, the clamping mechanism 10 includes a clamping block 11 for clamping the glass and a fixing member 12. Optionally, the clamping block 11 includes a first clamping portion 111, a second clamping portion 112, and a connecting portion 113 connecting the first clamping portion 111 and the second clamping portion 112. The first clamping portion 111 cooperates with the second clamping portion 112 to clamp the glass. The fixing member 12 is a screw.

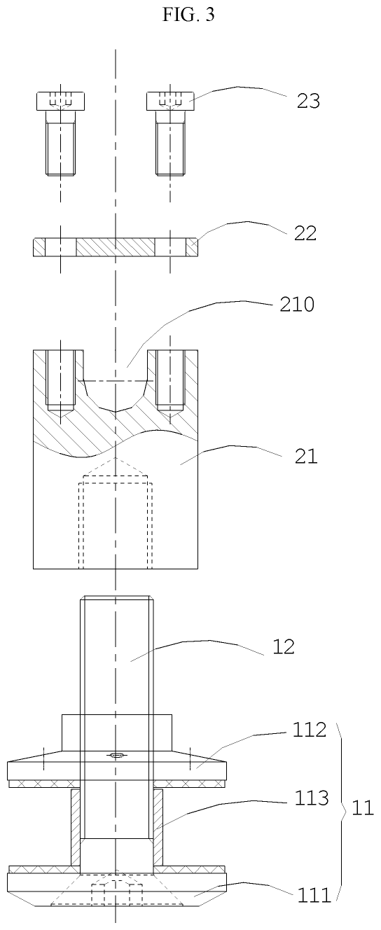

As shown in FIG. 3, the transverse arm mechanism 20 includes a mounting base 21, a positioning member 22, and a fastening member 23. The fixing member 12 connects the clamping block 11 and the mounting base 21. The positioning member 22 is connected to one end of the mounting base 21 away from the clamping mechanism 10. The fastening member 23 is configured to connect the positioning member 22 and the mounting base 21. Optionally, the mounting base 21 is provided with a receiving groove 210. The fastening member 23 is a bolt. Further, the receiving groove 210 is a U-shaped groove. The fixing member 12 is threadedly connected to the mounting base 21, and the fastening member 23 is threadedly connected to the mounting based 21.

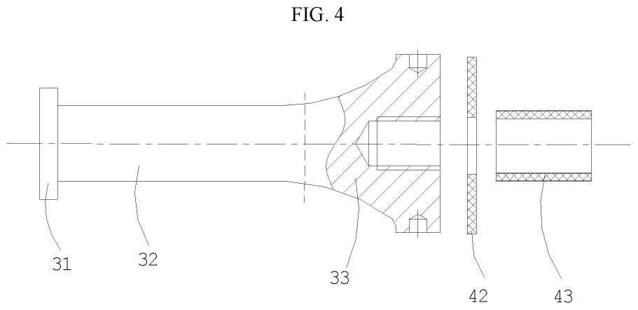

As shown in FIG. 4, the main arm member 30 extends through the mounting base 21. The main arm member 30 includes a latching portion 31, a guiding portion 32, and a limiting portion 33 that are sequentially connected. The latching portion 31 protrudes from the guiding portion 32. The guiding portion 32 is slidably arranged in the mounting base 21. Optionally, the guiding portion 32 is a straight rod, and a width of the cross-section of the limiting portion 33 gradually increases from one end thereof adjacent to the guiding portion 32 to the other end thereof. Moreover, the size of the latching portion 31 is larger than the size of the receiving groove 210 of the mounting base 21, the largest width of the cross-section of the limiting portion 33 is larger than the size of the receiving groove 210, so as to stop the main arm member 30 in the mounting base 21.

In an embodiment, the connecting mechanism 40 is provided with a connecting rod 41. The connecting rod 41 is connected to the building structural parts. The connecting rod 41 is connected to the limiting portion 33 of the main arm member 30. Optionally, the connecting rod 41 is threadedly connected to the limiting portion 33. The connecting rod 41 is a screw. In order to protect the supporting structure body of the curtain wall, such as glass ribs, the connecting mechanism 40 further includes a buffer member 42. The buffer member 42 is connected to one end of the main arm member 30. The connecting rod 41 extends through the buffer member 42. Moreover, the connecting mechanism 40 further includes a sleeve 43. The sleeving 43 is connected to an outside of the buffer member 42. The sleeve 43 is sleeved on the connecting rod 41. In use, the guiding portion 32 is provided in the receiving groove 210 of the mounting base 21, and the positioning member 22 and the mounting base 21 are fixed by the fastening member 23.

In use, the clamping block 11 clamps the glass. The guiding portion 32 is provided in the receiving groove 210 of the mounting base 21, and the positioning member 22 and the mounting base 21 are fixed by the fastening member 23. The connecting rod 41 is connected to the building structural parts. Therefore, the self-weight, wind load, earthquake load and the like of the glass can be transmitted to the building structural parts, so that the stability of the curtain wall system can still be ensured under the irresistible factors such as hurricanes and strong earthquakes.

According to the connecting device 100 of the present disclosure, the clamping block 11, the mounting base 21, the main arm member 30, and the connecting rod 41 are connected as a whole, and the clamping block 11 clamps the glass, the connecting rod 41 is connected to the building structural parts, thus, the self-weight, wind load, earthquake load and the like of the glass can be transmitted to the building structural parts. The connecting device 100 according to the present disclosure has a simple structure and is convenient to use. It can ensure the stability of the curtain wall system and improve the safety performance of the curtain wall system under the strong loads such as hurricanes and earthquakes.

### Embodiment 2

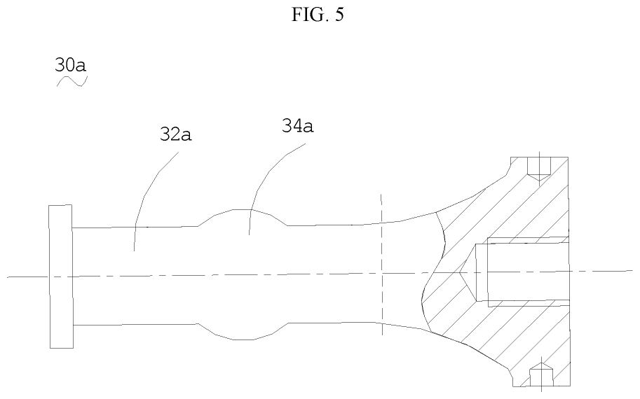

Referring to FIG. 5, it shows a main arm member 30a of a connecting device according to a second embodiment of the present disclosure. The connecting device of this embodiment is similar to the connecting device 100 of the first embodiment, and the difference lies in that the main arm member 30a of the connecting device of this embodiment further includes a convex block 34a. The convex block 34a protrudes from a guiding portion 32a. Optionally, the convex block 34a is a spherical protrusion. Since the spherical protrusion allows the mounting base to rotate by a certain angle relative to the main arm member 30a, the glass is allowed to perform a certain degree of movement when the glass is subjected to a high wind load. In addition, the spherical protrusion increases the rotation of the mounting base and helps dissipate energy into the connecting rod with better ductility, thereby providing reduced impact resistance on glass.

### Embodiment 3

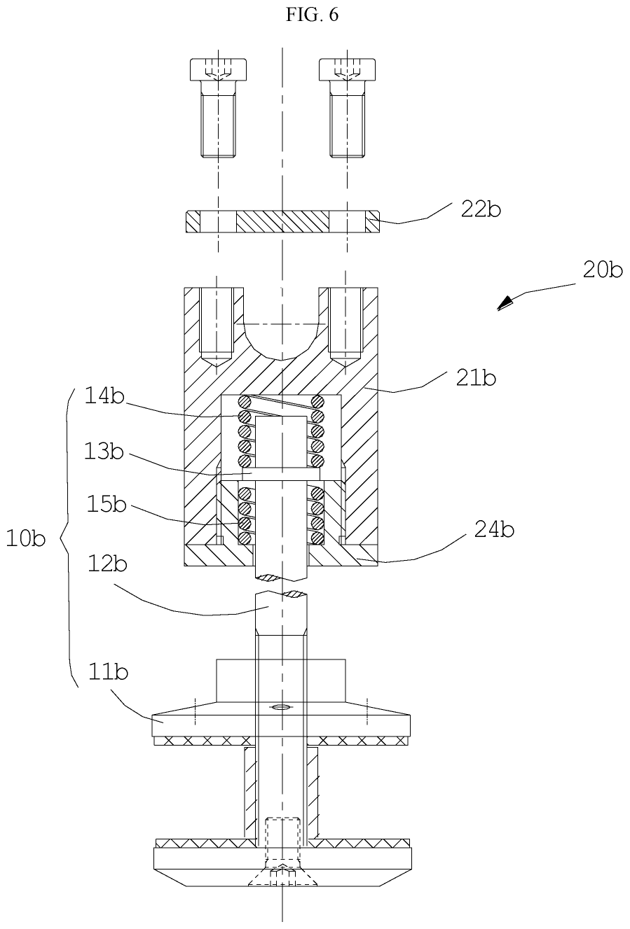

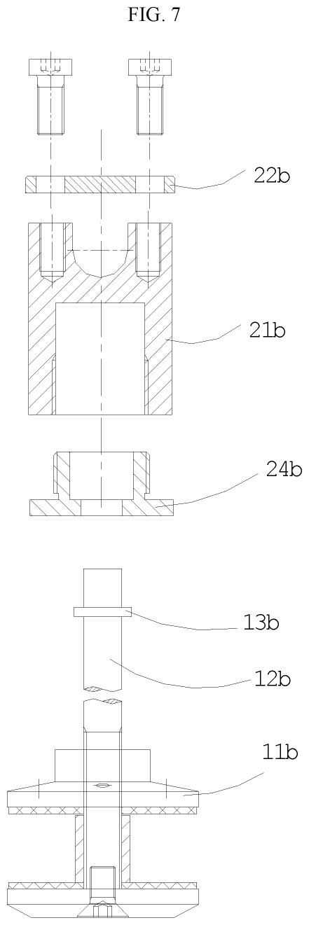

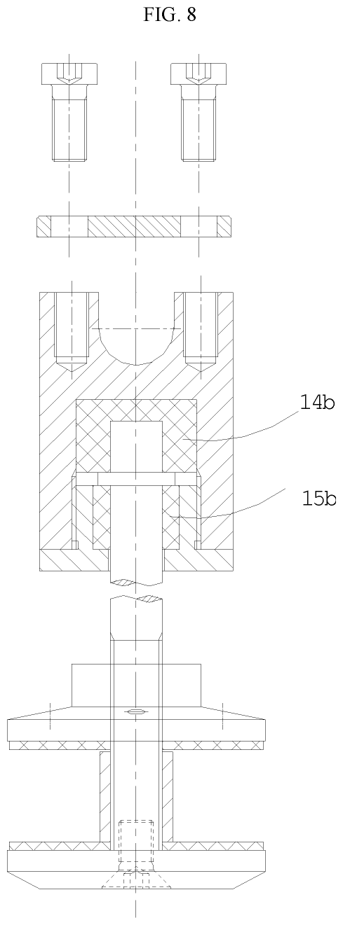

Referring to FIGS. 6 and 7, it shows a connecting device according to a third embodiment of the present disclosure. The connecting device of this embodiment is similar to the connecting device 100 of the first embodiment, and the difference lies in that a clamping mechanism 10b of the connecting device of this embodiment further includes an abutting block 13b, and a first elastic member 14b and a second elastic member 15b that are sleeved on an end of a fixing member 12b away from a clamping block 11b. The abutting block 13b is connected to the end of the fixing member 12b away from the clamping block 11b. Both sides of the abutting block 13b abut against the first elastic member 14b and the second elastic member 15b, respectively. Optionally, both of the first elastic member 14b and the second elastic member 15b are springs. In other embodiments, both of the first elastic member 14b and the second elastic member 15b are rubber pads, as shown in FIG. 8. A transverse arm mechanism 20b of the connecting device according to this embodiment further includes a fixing base 24b. The fixing base 24b is connected to an end of a mounting base 21b away from a positioning member 22b. The fixing member 12b is inserted into the mounting base 21b. One end of the first elastic member 14b abuts against the mounting base 21b, the other end thereof abuts against the abutting block 13b. One end of the second elastic member 15b abuts against the mounting base 21b, the other end thereof abuts against the abutting block 13b. Subjected to the abutting block 13b, the first elastic member 14b and the second elastic member 15b, the fixing member 12b is slidably arranged in the mounting base 21b. When the length and width of the glass is relatively large, the glass has the largest deflection deformation in the middle portion. Subjected to a wind pressure, the abutting block 13b compresses the first elastic member 14b to deform and enable the fixing member 12b to move, thereby adapting and limiting the deflection deformation of the glass within a certain range, improving the rigidity of the glass and reducing the stress concentration caused by over-positioning.

### Embodiment 4

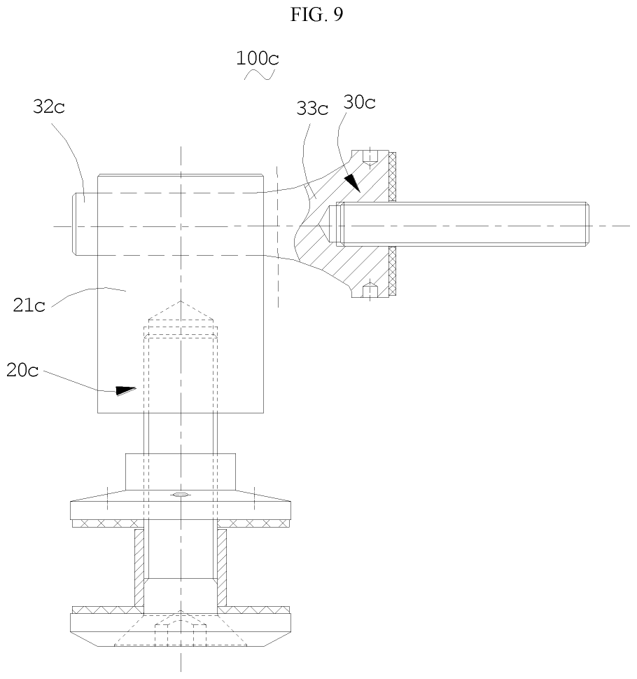

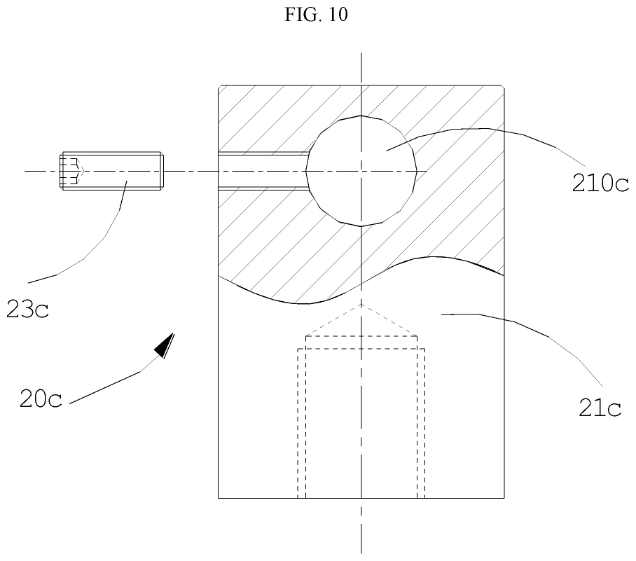

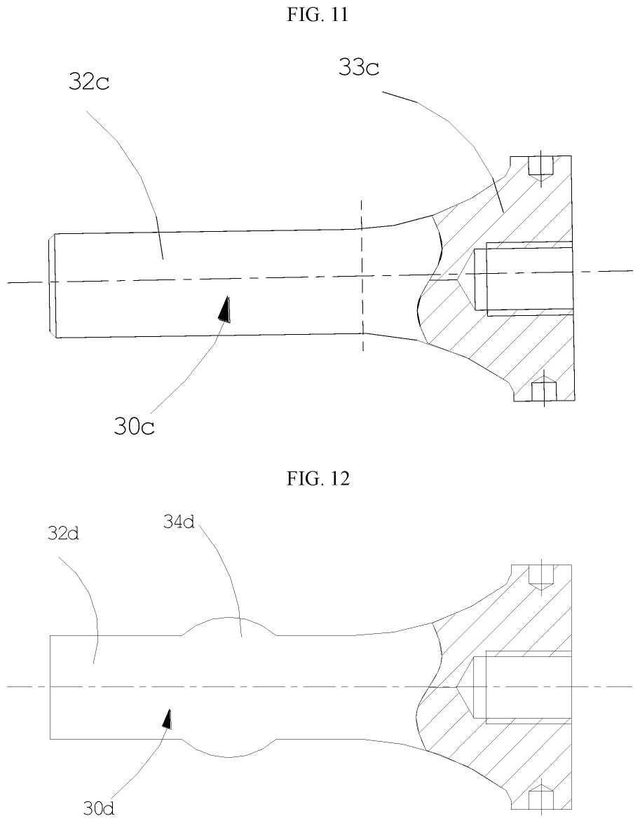

Referring to FIGS. 9 and 11, it shows a connecting device 100c according to a fourth embodiment of the present disclosure. The connecting device of this embodiment is similar to the connecting device 100 of the first embodiment, and the difference lies in that a transverse arm mechanism 20c of the connecting device 100c of this embodiment includes a mounting base 21c and a fastening member 23c. A main arm member 30c extends through the mounting base 21c. The fastening member 23c is configured to connect the main arm member 30c and the mounting base 21c. Optionally, the mounting base 21c is provided with a through hole 201c allowing the main arm member 30c to extend through. The fastening member 23c extends through one side of the mounting base 21c and thus abuts against the main arm member 30c. Further, the main arm member 30c includes a guiding portion 32c and a limiting portion 33c that are sequentially connected. The guiding portion 32c is slidably arranged in the mounting base 21c. The limiting portion 33c is connected to the connecting rod. Optionally, the guiding portion 32c is a straight rod, and the width of the cross-section of the limiting portion 33c gradually increases from one end thereof adjacent to the guiding portion 32c to the other end thereof. Moreover, the largest width of the cross-section of the limiting portion 33c is larger than the size of the through hole 201c, so as to stop the main arm member 30c in the mounting base 21c.

### Embodiment 5

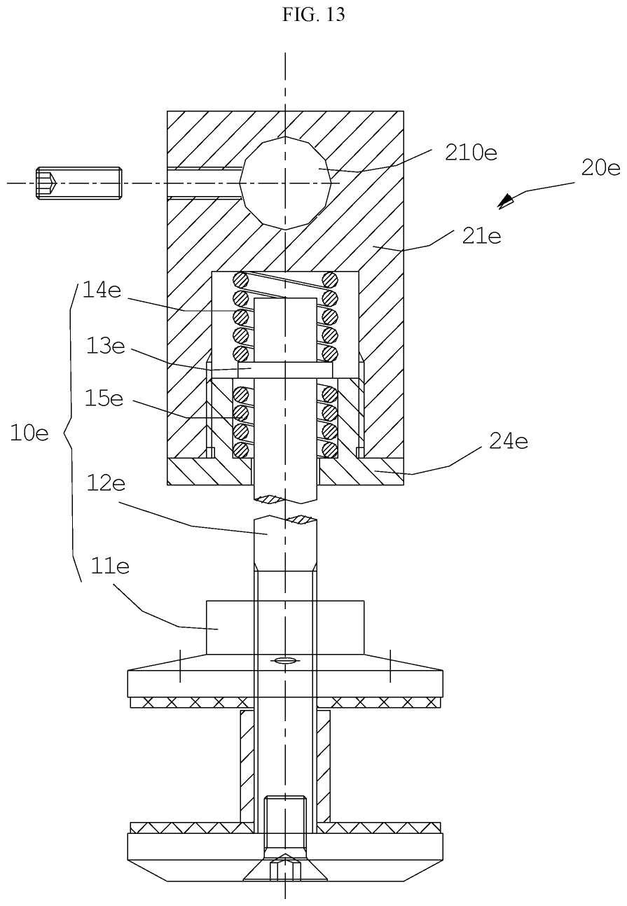

Referring to FIG. 12, it shows a main arm member 30d of a connecting device according to a fifth embodiment of the present disclosure. The connecting device of this embodiment is similar to the connecting device 100c of the third embodiment, and the difference lies in that the main arm member 30d of the connecting device of this embodiment further includes a convex block 34d. The convex block 34d protrudes from a guiding portion 32d. Optionally, the convex block 34d is a spherical protrusion. Since the spherical protrusion allows the mounting base to rotate by a certain angle relative to the main arm member 30d, the glass is allowed to perform a certain degree of movement when the glass is subjected to a high wind load. In addition, the spherical protrusion increases the degree of rotation of the mounting base and helps dissipate energy into the connecting rod with better ductility, thereby providing reduced impact resistance on glass.

### Embodiment 6

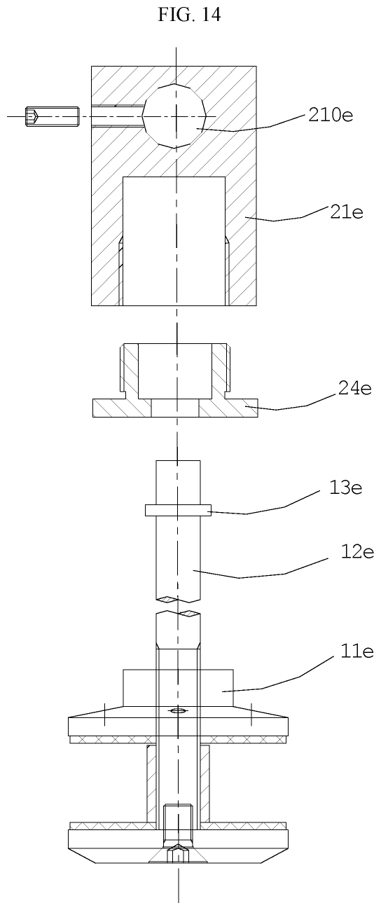

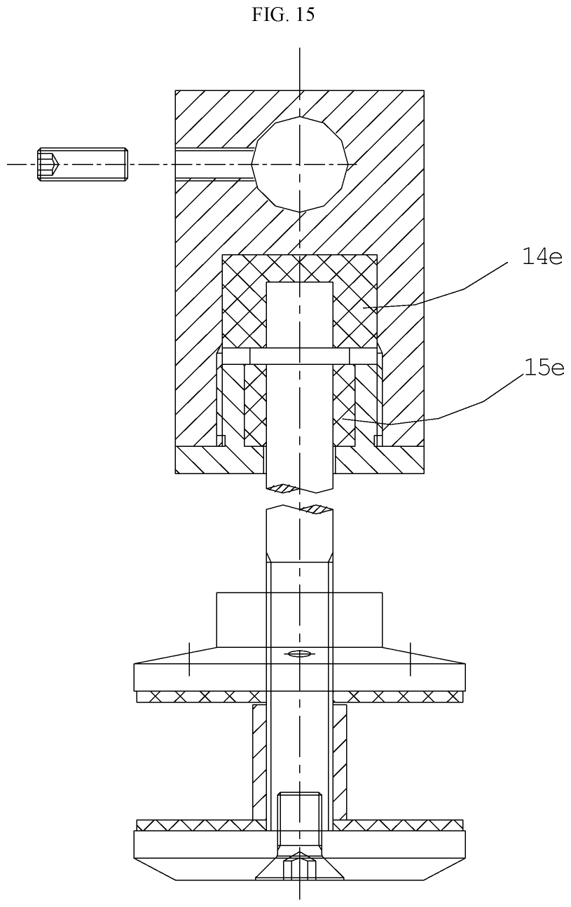

Referring to FIGS. 13 and 14, it shows a connecting device according to a sixth embodiment of the present disclosure. The connecting device of this embodiment is similar to the connecting device 100c of the fourth embodiment, and the difference lies in that a clamping mechanism 10e of the connecting device of this embodiment further includes an abutting block 13e, and a first elastic member 14e and a second elastic member 15e that are sleeved on an end of a fixing member 12e away from a clamping block 11e. The abutting block 13e is connected to the end of the fixing member 12e away from the clamping block 11e. Both sides of the abutting block 13e abut against the first elastic member 14e and the second elastic member 15e, respectively. Optionally, both of the first elastic member 14e and the second elastic member 15e are springs. In other embodiments, both of the first elastic member 14e and the second elastic member 15e are rubber pads, as shown in FIG. 15. A transverse arm mechanism 20e of the connecting device according to this embodiment further includes a fixing base 24e. The fixing base 24e is connected to an end of a mounting base 21e away from a through hole 210e. The fixing member 12e is inserted into the mounting base 21e. One end of the first elastic member 14e abuts against the mounting base 21e, the other end thereof abuts against the abutting block 13e. Subjected to the abutting block 13e, the first elastic member 14e and the second elastic member 15e, the fixing member 12e is slidably arranged in the mounting base 21e. When the length and width of the glass is relatively large, the glass has the largest deflection deformation in the middle portion. Subjected to a wind pressure, the abutting block 13e compresses the first elastic member 14e to deform and enable the fixing member 12e to move, thereby adapting and limiting the deflection deformation of the glass within a certain range, improving the rigidity of the glass and reducing the stress concentration caused by over-positioning.

Each the technical features of the embodiments described above can be arbitrarily combined. In order to simplify the description, all possible combinations of each technical features in the above embodiments have not been described. However, as long as there is no contradiction in the combination of these technical features, it should be considered as that all of them fall within the scope recorded in this specification.

The above described embodiments only present several implementation manners of the present disclosure, and descriptions thereof are more specific and detailed, but they cannot be understood as limiting the scope of the application patent. It should be noted that, to those of ordinary skill in the art, several modifications and improvements can be made without departing from the concept of the present disclosure, which all fall within the protection scope of the present disclosure. Therefore, the protection scope of this application patent shall be subject to the appended claims.

What is claimed is:

1. A connecting device, comprising a clamping mechanism, a transverse arm mechanism, a main arm member, and a connecting mechanism that are sequentially connected,
wherein the clamping mechanism comprises a clamping block and a fixing member,
the transverse arm mechanism comprises a mounting base, a positioning member, and a fastening member,
the fixing member connects the clamping block and the mounting base,
the positioning member is connected to one end of the mounting base away from the clamping mechanism,
the fastening member connects the positioning member and the mounting base,
the main arm member extends through the mounting base,
the connecting mechanism is provided with a connecting rod connected to the main arm member.

2. The connecting device according to claim 1, wherein the main arm member comprises a latching portion, a guiding portion, and a limiting portion that are sequentially connected, the latching portion protrudes from the guiding portion, the guiding portion is slidably arranged in the mounting base, and the limiting portion is connected to the connecting rod.

3. The connecting device according to claim 2, wherein a width of a cross-section of the limiting portion gradually increases from one end thereof adjacent to the guiding portion to the other end thereof.

4. The connecting device according to claim 2, wherein the main arm member further comprises a convex block protruding from the guiding portion.

5. The connecting device according to claim 1, wherein the clamping block comprises a first clamping portion, a second clamping portion, and a connecting portion connecting the first clamping portion and the second clamping portion, the first clamping portion cooperates with the second clamping portion to clamp a glass.

6. The connecting device according to claim 1, wherein the clamping mechanism further comprises an abutting block, and a first elastic member and a second elastic member that are sleeved on an end of the fixing member away from the clamping block, both sides of the abutting block abut against the first elastic member and the second elastic member, respectively.

7. A connecting device, comprising a clamping mechanism, a transverse arm mechanism, a main arm member, and a connecting mechanism that are sequentially connected,
wherein the clamping mechanism comprises a clamping block and a fixing member,
the transverse arm mechanism comprises a mounting base and a fastening member,
the fixing member connects the clamping block and the mounting base,
the main arm member extends through the mounting base,
the fastening member connects the main arm member and the mounting base,
the connecting mechanism is provided with a connecting rod connected to the main arm member.

8. The connecting device according to claim 7, wherein the clamping mechanism further comprises an abutting block, and a first elastic member and a second elastic member that are sleeved on an end of the fixing member away from the clamping block, both sides of the abutting block abut against the first elastic member and the second elastic member, respectively.

9. The connecting device according to claim 7, wherein the main arm member comprises a guiding portion and a limiting portion that are sequentially connected, the guiding portion is slidably arranged in the mounting base, and the limiting portion is connected to the connecting rod.

10. The connecting device according to claim 9, wherein the main arm member further comprises a convex block protruding from the guiding portion.
